(19) United States
(12) Patent Application Publication
(10) Pub. No.: US 2025/0071645 A1
(43) Pub. Date: Feb. 27, 2025

(54) APPARATUS, METHOD, AND COMPUTER PROGRAM

(71) Applicant: NOKIA TECHNOLOGIES OY, Espoo (FI)

(72) Inventors: Umur KARABULUT, Munich (DE); Ahmad AWADA, Munich (DE); Ingo VIERING, Munich (DE); Subhyal BIN IQBAL, Munich (DE)

(21) Appl. No.: 18/728,381

(22) PCT Filed: Jan. 13, 2022
(86) PCT No.: PCT/EP2022/050631

§ 371 Date: Jul. 11, 2024

(51) Int. Cl. H04W 36/24; H04W 36/36

(52) U.S. Cl. CPC H04W 36/249; H04W 36/362

(57) ABSTRACT

An apparatus comprising means configured to: determine sampling rate information which controls a rate at which an antenna panel of a communications device makes cell measurements; and determine one or more mobility related parameters based on information received from a network entity about mobility related parameters for the determined sampling rate information.

### FIELD OF THE DISCLOSURE

The present disclosure relates to an apparatus, a method, and a computer program for controlling a communications device having one or more antenna panels.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined.

### SUMMARY

According to an aspect, there is provided an apparatus comprising means configured to: determine sampling rate information which controls a rate at which an antenna panel of a communications device makes cell measurements; and determine one or more mobility related parameters based on information received from a network entity about mobility related parameters for the determined sampling rate information.

The means may be configured to determine for each of a plurality of different antenna panels of the communications device, respective sampling rate information and associated mobility related parameters.

The information received from a network about mobility related parameters may comprise cell specific information.

The means may be configured to receive the information from the network entity about mobility related parameters for a plurality of different sample rates.

The means may be configured to receive the information from the network entity about mobility related parameters for the plurality of different sample rates for a plurality of different cells.

The means may be configured to receive information about one or more conditions and to use the information about one or more conditions to determine which mobility parameters are to be used.

The means may be configured to cause the sampling rate information to be sent by the communications device to the network entity and in response to receive the information from the network entity about mobility related parameters for the sampling rate information.

The means may be configured to cause cell identity information associated with the sampling rate information to be sent by the communications device to the network entity and in response to receive the information from the network entity about mobility related parameters for the determined sampling rate information for the identified cell.

The mobility parameters may be handover related parameters.

The mobility parameters may comprise one or more of time to trigger, a handover offset and a L3 filter coefficient.

The apparatus may be or provided in a communications device.

According to another aspect there is provided an apparatus comprising at least one processor and at least one memory including computer code for one or more programs, the at least one memory and the computer code configured, with the at least one processor, to cause the apparatus at least to: determine sampling rate information which controls a rate at which an antenna panel of a communications device makes cell measurements; and determine one or more mobility related parameters based on information received from a network entity about mobility related parameters for the determined sampling rate information.

The at least one memory and the computer program code may be configured to, with the at least one processor, cause the apparatus at least to determine for each of a plurality of different antenna panels of the communications device, respective sampling rate information and associated mobility related parameters.

The information received from a network about mobility related parameters may comprise cell specific information.

The at least one memory and the computer program code may be configured to, with the at least one processor, cause the apparatus at least to receive the information from the network entity about mobility related parameters for a plurality of different sample rates.

The at least one memory and the computer program code may be configured to, with the at least one processor, cause the apparatus at least to receive the information from the network entity about mobility related parameters for the plurality of different sample rates for a plurality of different cells.

The at least one memory and the computer program code may be configured to, with the at least one processor, cause the apparatus at least to receive information about one or more conditions and to use the information about one or more conditions to determine which mobility parameters are to be used.

The at least one memory and the computer program code may be configured to, with the at least one processor, cause the apparatus at least to cause the sampling rate information to be sent by the communications device to the network entity and in response to receive the information from the network entity about mobility related parameters for the sampling rate information.

The at least one memory and the computer program code may be configured to, with the at least one processor, cause the apparatus at least to cause cell identity information associated with the sampling rate information to be sent by the communications device to the network entity and in response to receive the information from the network entity about mobility related parameters for the determined sampling rate information for the identified cell.

The mobility parameters may be handover related parameters.

The mobility parameters may comprise one or more of time to trigger, a handover offset and a L3 filter coefficient.

The apparatus may be or provided in a communications device.

According to an aspect, there is provided a method comprising: determining sampling rate information which controls a rate at which an antenna panel of a communications device makes cell measurements; and determining one or more mobility related parameters based on information received from a network entity about mobility related parameters for the determined sampling rate information.

The method may comprise determining for each of a plurality of different antenna panels of the communications device, respective sampling rate information and associated mobility related parameters.

The information received from a network about mobility related parameters may comprise cell specific information.

The method may comprise receiving the information from the network entity about mobility related parameters for a plurality of different sample rates.

The method may comprise receiving the information from the network entity about mobility related parameters for the plurality of different sample rates for a plurality of different cells.

The method may comprise receiving information about one or more conditions and to use the information about one or more conditions to determine which mobility parameters are to be used.

The method may comprise causing the sampling rate information to be sent by the communications device to the network entity and in response to receive the information from the network entity about mobility related parameters for the sampling rate information.

The method may comprise causing cell identity information associated with the sampling rate information to be sent by the communications device to the network entity and in response to receive the information from the network entity about mobility related parameters for the determined sampling rate information for the identified cell.

The mobility parameters may be handover related parameters.

The mobility parameters may comprise one or more of time to trigger, a handover offset and a L3 filter coefficient.

The method may be performed by an apparatus. The apparatus may be or provided in a communications device.

According to another aspect, there is provided an apparatus comprising means configured to: receive sampling rate information from a communications device, the sampling rate information controlling a rate at which an antenna panel of the communications device makes cell measurements; and in response cause information to be sent to the communications device, said information being about mobility related parameters for the sampling rate information.

The sampling rate information may comprise respective sampling rate information for each of a plurality of different antenna panels of the communications device.

The means may be configured to receive cell identity information associated with the sampling rate information from the communications device and in response to cause the information to be sent to the communications device about mobility related parameters for the determined sampling rate information for the identified cell.

The mobility parameters may be handover related parameters.

The mobility parameters may comprise one or more of time to trigger, a handover offset and a L3 filter coefficient.

The apparatus may be or provided in a network entity.

According to another aspect there is provided an apparatus comprising at least one processor and at least one memory including computer code for one or more programs, the at least one memory and the computer code configured, with the at least one processor, to cause the apparatus at least to: receive sampling rate information from a communications device, the sampling rate information controlling a rate at which an antenna panel of the communications device makes cell measurements; and in response cause information to be sent to the communications device, said information being about mobility related parameters for the sampling rate information.

The sampling rate information may comprise respective sampling rate information for each of a plurality of different antenna panels of the communications device.

The at least one memory and the computer program code may be configured to, with the at least one processor, cause the apparatus at least to receive cell identity information associated with the sampling rate information from the communications device and in response to cause the information to be sent to the communications device about mobility related parameters for the determined sampling rate information for the identified cell.

The mobility parameters may be handover related parameters.

The mobility parameters may comprise one or more of time to trigger, a handover offset and a L3 filter coefficient.

The apparatus may be or provided in a network entity.

According to another aspect, there is provided a method comprising: receiving sampling rate information from a communications device, the sampling rate information controlling a rate at which an antenna panel of the communications device makes cell measurements; and in response causing information to be sent to the communications device, said information being about mobility related parameters for the sampling rate information.

The sampling rate information may comprise respective sampling rate information for each of a plurality of different antenna panels of the communications device.

The method may comprise receiving cell identity information associated with the sampling rate information from the communications device and in response to cause the information to be sent to the communications device about mobility related parameters for the determined sampling rate information for the identified cell.

The mobility parameters may be handover related parameters.

The mobility parameters may comprise one or more of time to trigger, a handover offset and a L3 filter coefficient.

The method may be performed by an apparatus. The apparatus may be or provided in a network entity.

According to another aspect, there is provided an apparatus comprising means configured to: cause information to be sent to a communications device, said information being about mobility related parameters for a plurality of different sampling rates to control a rate at which one or more antenna panels of the communications device makes cell measurements.

The information about mobility related parameters may comprise cell specific information.

The means may be configured to cause information about one or more conditions to be sent to the communications device, said one or more conditions being used by the communications device to determine which mobility parameters are to be used.

The mobility parameters may be handover related parameters.

The mobility parameters may comprise one or more of time to trigger, a handover offset and a L3 filter coefficient.

The apparatus may be or provided in a network entity.

According to another aspect there is provided an apparatus comprising at least one processor and at least one memory including computer code for one or more programs, the at least one memory and the computer code configured, with the at least one processor, to cause the apparatus at least to: cause information to be sent to a communications device, said information being about mobility related parameters for a plurality of different sampling rates to control a rate at which one or more antenna panels of the communications device makes cell measurements.

The information about mobility related parameters may comprise cell specific information.

The at least one memory and the computer program code may be configured to, with the at least one processor, cause the apparatus at least to cause information about one or more conditions to be sent to the communications device, said one or more conditions being used by the communications device to determine which mobility parameters are to be used.

The mobility parameters may be handover related parameters.

The mobility parameters may comprise one or more of time to trigger, a handover offset and a L3 filter coefficient.

The apparatus may be or provided in a network entity.

According to another aspect, there is provided a method comprising: causing information to be sent to a communications device, said information being about mobility related parameters for a plurality of different sampling rates to control a rate at which one or more antenna panels of the communications device makes cell measurements.

The information about mobility related parameters may comprise cell specific information.

The method may comprise causing information about one or more conditions to be sent to the communications device, said one or more conditions being used by the communications device to determine which mobility parameters are to be used.

The mobility parameters may be handover related parameters.

The mobility parameters may comprise one or more of time to trigger, a handover offset and a L3 filter coefficient.

The method may be performed by an apparatus. The apparatus may be or provided in a network entity.

According to another aspect, there is provided a computer readable medium comprising program instructions for causing an apparatus to perform at least the method according to any of the preceding aspects.

According to an aspect, there is provided a non-transitory computer readable medium comprising program instructions for causing an apparatus to perform at least the method according to any of the preceding aspects.

According to an aspect, there is provided a non-volatile tangible memory medium comprising program instructions stored thereon for performing at least one of the above methods.

In the above, many different embodiments have been described. It should be appreciated that further embodiments may be provided by the combination of any two or more of the embodiments described above.

Various other aspects are also described in the following detailed description and in the attached claims.

### BRIEF DESCRIPTION OF THE FIGURES

Embodiments will now be described, by way of example only, with reference to the accompanying Figures in which:

FIG. 1 shows an example system architecture;

FIG. 2 shows a schematic diagram of an example 5G core network and radio access part;

FIG. 3 shows a schematic diagram of an example apparatus;

FIG. 4 shows a schematic diagram of a communications device;

FIG. 5 shows a user is holding a multi-panel user equipment (MPUE);

FIG. 6 shows the radiation pattern of each of the antenna panels of the MPUE of FIG. 5;

FIG. 7 shows handover of a UE from serving cell co to neighbor cell c′ along with associated L3 measurements;

FIGS. 8a to d illustrate an example mobility scenario, as simulated;

FIG. 9 shows the simulation scenario used for FIGS. 8a to d;

FIG. 10 shows a first method of some embodiments which uses network controlled mobility parameter adaptation for changing the sampling rate per panel per cell;

FIG. 11 shows a second method of some embodiments which uses a user equipment autonomous mobility parameter adaptation for changing sampling rate per panel per cell;

FIG. 12 shows a method of some embodiments performed by an apparatus;

FIG. 13 shows a method of some embodiments performed by an apparatus;

FIG. 14 shows a method of some embodiments performed by an apparatus;

FIG. 15 shows a schematic representation of a non-volatile memory medium storing instructions which when executed by a processor allow a processor to perform one or more of the steps of the method of FIG. 12, 13 or 14.

### DETAILED DESCRIPTION OF THE FIGURES

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

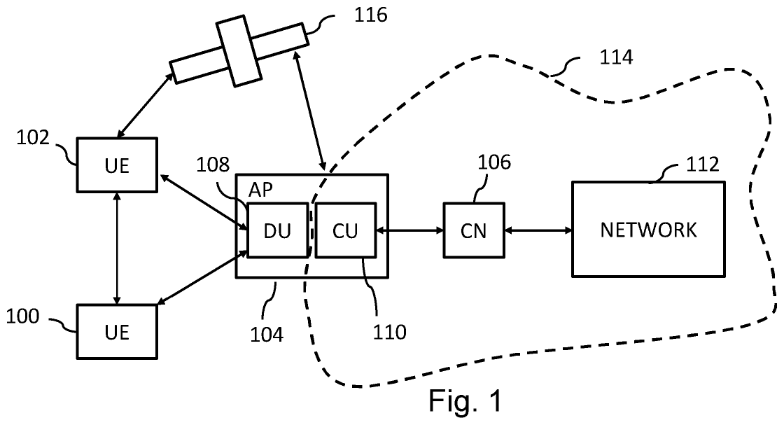

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as a base station or (e/g) NodeB serving devices in a cell. In one example, the node 104 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server, or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 106 (CN or next generation core NGC). Depending on the deployed technology, the (e/g) NodeB is connected to a serving and packet data network gateway (S-GW and P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc.

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, a wireless interface card or other wireless interface facility (e.g., USB dongle) and multimedia device. It should be appreciated that a device may also be a nearly exclusive uplink only device, of which an example is a camera or video camera loading images or video clips to a network. The device may be a machine-type communications (MTC) device or an Internet of things (IoT) type communication device. The device may be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones, or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors, and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, 6 or above 24 GHz-cmWave and mmWave).

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets, and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes, or hosts. Application of cloud RAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements proposed to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the device may have access to a plurality of radio cells and the system may comprise also other apparatuses, such as physical layer relay nodes or other network elements, etc. At least one of the (e/g) NodeBs or may be a Home (e/g) NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) gNodeBs), a home node B gateway, or HNB-GW (not shown in FIG. 1). A HNB Gateway (HNB-GW), which is typically installed within an operator's network may aggregate traffic from a large number of HNBs back to a core network.

In the following examples, the communications device is referred to as a UE. However, it should be appreciated that the communication device can any suitable communications device, some examples of which have already been mentioned.

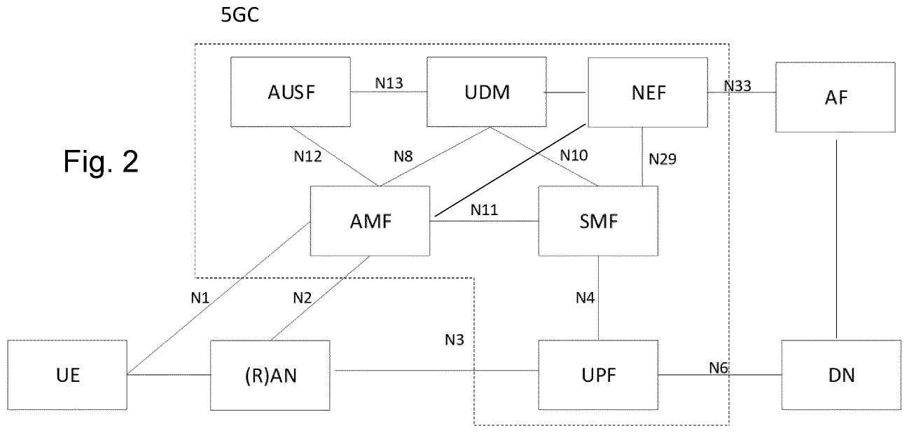

FIG. 2 shows a schematic representation of a 5G system (5GS). The 5GS may comprises a terminal, a (radio) access network ((R)AN), a 5G core network (5GC), one or more application functions (AF) and one or more data networks (DN). The 5G (R)AN may comprise one or more gNodeB (gNB) distributed unit functions connected to one or more gNodeB (gNB) centralized unit functions. The 5GC may comprise an access management function (AMF), a session management function (SMF), an authentication server function (AUSF), a user data management (UDM), a user plane function (UPF) and/or a network exposure function (NEF).

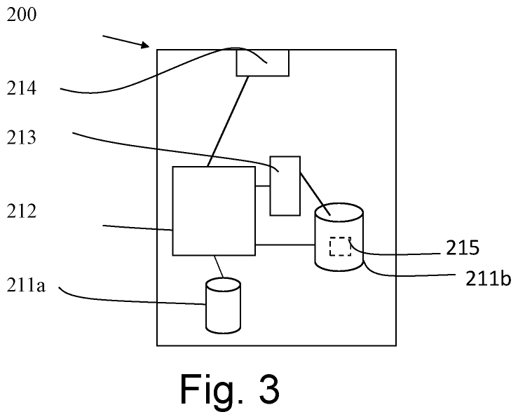

FIG. 3 illustrates an example of an apparatus 200. The apparatus may be provided in or be a communications device. The apparatus may be provide in or be a base station other access node. The apparatus may comprise at least one random access memory (RAM) 211a, at least one read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b.

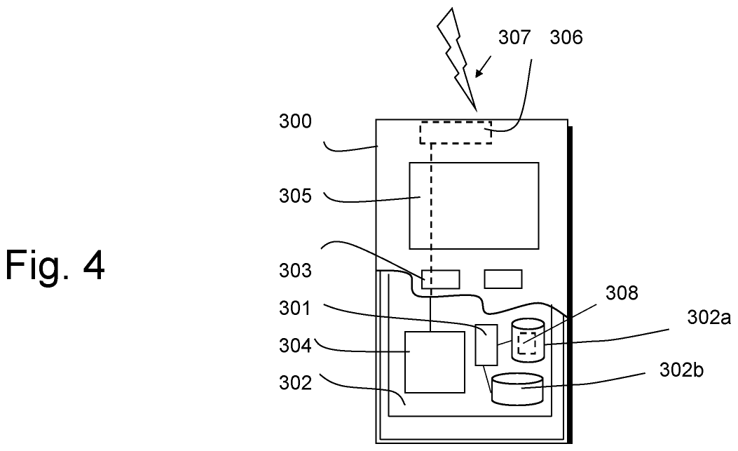

FIG. 4 illustrates an example of a communications device 300, such as the communications device illustrated on FIG. 1. The communications device 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The communications device 300 may provide, for example, communication of data for carrying communications. The communications may be one or more of voice, electronic mail (email), text message, multimedia, data, machine data and so on.

The communications device 300 may receive signals over an air or radio interface 307 via appropriate apparatus for receiving and may transmit signals via appropriate apparatus for transmitting radio signals. In FIG. 4 transceiver apparatus is designated schematically by block 306. The transceiver apparatus 306 may be provided for example by means of a radio part and associated antenna arrangement. The antenna arrangement may be arranged internally or externally to the mobile device.

The communications device 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 211b. The at least one processor 301 may be configured to execute an appropriate software code 308. The software code 308 may for example allow to perform one or more of the present aspects. The software code 308 may be stored in the ROM 302b.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

With the introduction of mmWave (millimetre wave) in 3GPP 5G NR, the need to compensate for additional path loss at higher frequencies leads to a proposal for antenna arrays at the base stations and user equipment (UE). Patch arrays for mmWave at UE level are directive, for example with a front-to-back ratio pf up to 30 dB. As a result, multiple array panels covering multiple spatial directions may be provided.

Whilst some embodiments are described where mmWaves are used, it should be appreciated that other embodiments may be used with other wavelengths.

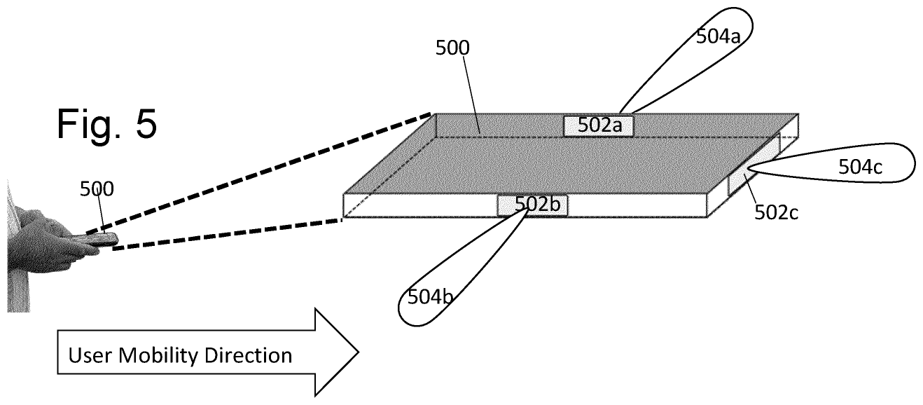

One example is shown in FIG. 5 where a user is holding a multi-panel user equipment (MPUE) 500 which has three panels 502a, 502b and 502c. Each panel has a directional pattern 504a, 504b and 504c on different directions to cover the multiple spatial directions.

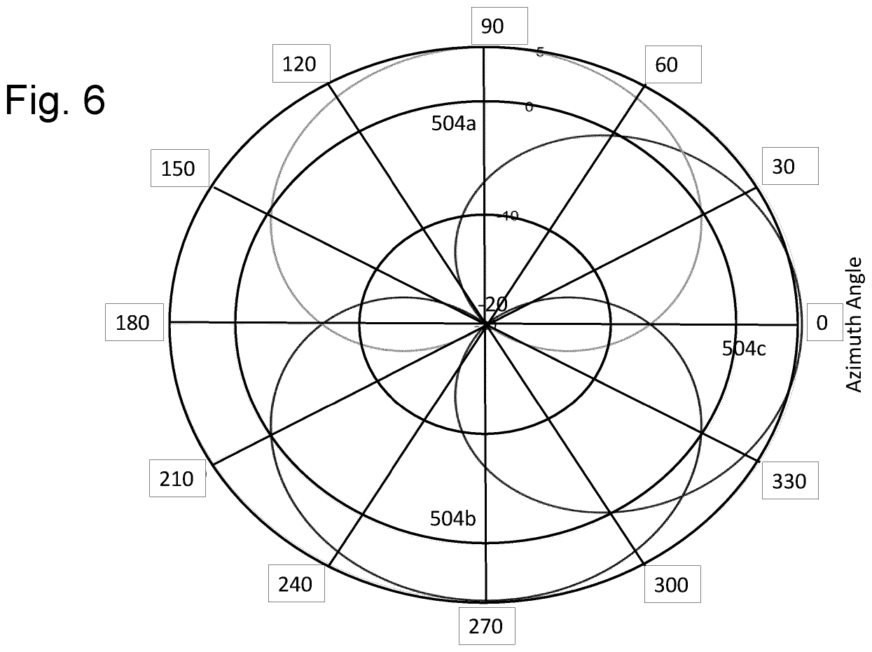

FIG. 6 shows the radiation pattern 504a, 504b and 504c of each antenna panels in 2D and each panel has 5 dBi antenna gain and 25 dB backwards attenuation.

Depending on the UE hardware architecture, MPUEs can activate all panels simultaneously for simultaneous measurements of serving cell and neighbour cell powers. However, each panel can be activated independently with different activation frequency. The activation periodicity of each panel determines the sampling rate of each panel, i.e., how often a panel does sampling of cell measurements over time.

In mobile networks, UE connects to the network through a cell which provides a good link quality, i.e., link with signal-to-interference-noise-ratio above a certain threshold. If the UE moves away from the serving gNB and gets closer to another neighbour cell (or target cell), the received signal power of the serving cell degrades and the interference from the target cell becomes dominant. Eventually, UE handovers to the target cell to sustain the connection to the network.

Received signal power of the serving cell is compared against that of target cell to determine whether it is necessary to handover the connection of a UE from serving cell to another. Those received signal power measurements may fluctuate due to channel impairments, e.g., fast-fading, measurement error and shadow fading. Using those measurements without any filtering leads to wrong decisions due to rapid fluctuations and uncertainty on the measured signals. To mitigate those impairments and uncertainty (to prevent erroneous decisions) those raw measurements are filtered using a moving average filter (L1 filter) and a recursive filter (L3 filter) which provides smooth measurement at the expense of delay in the measurements (due to filtering).

UE measurements are part of the mobility in mobile networks. UEs measure the quality of the serving cell and neighbour cells and those measurements are used to decide handover of a UE from one cell to another. Inaccurate cell quality measurements leads to faulty handover decisions in the network and causes UEs to experience service interruption, e.g., radio link failure (RLF), handover failure (HOF) or Ping-Pong (PP). Therefore, it is desirable for the UE to make accurate cell quality measurements to provide good mobility performance.

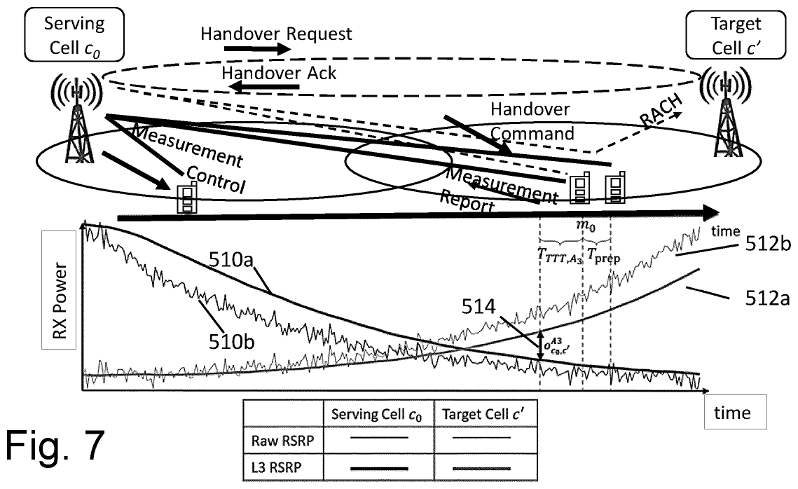

In FIG. 7, handover of a UE from serving cell co to neighbor cell c′ is illustrated along with the L3 measurements. The raw RSRP of the serving cell c₀ is referenced 510b and the L3 RSRP is referenced 510a. The raw RSRP of the neighbour cell c₁ is referenced 512b and the L3 RSRP is referenced 512a. During the handover procedure, L3 measurements (outputs of L3 filtering) from the serving and the neighbor cell are compared at UE. If L3 measurements of a neighbor cell c′ is offset o_{c}_{₀}_{,c′}^{A3} dB better than the L3 measurement of the serving cell c₀ for a time-to-trigger period T_{TTT} of time, the UE sends measurement report to the serving cell. FIG. 7 shows the offset o_{c}_{₀}_{,c′}^{A3} dB where the neighbour cell is better than the serving cell and this is referenced 514. The serving cell requests handover (by sending a handover request) to the target cell. If the target cell acknowledges the request (by sending a handover ACK), the serving cell sends the handover command to the UE. The UE initiates the handover with a random access (RACH) procedure right after receiving the handover command.

In the MPUE case, the number of measurements per cell is scaled up with the number of panels on the UE and the UE has to determine which panel measurements are to be used for assessing each cell quality measurement. It may happen that the measurements of the serving cell and target cell are obtained from different panels, e.g., panel #1 is used for serving cell measurements and panel #2 is used for target cell measurements since panel #1 and #2 give the strongest measurements for serving cell and target cell respectively.

Sampling rate per panel differs from UE to UE. This can be due to a various reasons. For example, this variation is sampling rate may be due to variation in hardware capabilities. A UE with multi-panel architecture may not be able to activate the multiple panels simultaneously for simultaneous measurements. In that case, the UE has to schedule the activation of the panels over time. A straightforward approach would be to use a round robin scheduler where one panel is activated at a time and one panel is activated after another panel is deactivated. A more complex approach would consider prioritization of the panels for certain mobility events, e.g., panels that are used in a most likely handover event (e.g., panel #1 and panel #2 from serving cell and target cell respectively, in the previously described example), will be prioritized and the sampling rate of those panels is increased for accurate measurements. The panel, panel #3, that is not needed in this most likely handover event is down-prioritized by reducing the sampling rate of that panel.

Sampling rate variation may be a result of power consumption constraints. The UE performs the cell quality measurements at the cost of power consumption. Even if the UE is capable of simultaneous measurement on all panels, the UE may use a lower sampling rate per panel to reduce the power consumption required for sampling. This reduced sampling rate may be used in the case that accurate measurements are not needed of if the UE is running out of battery power.

The sampling rate of each panel and the panel activation periodicity is currently the UE's decision and is implementation specific. In a MPUE case, panel sampling rate has a significant impact on mobility performance since it will determine the accuracy of the measurements where the UE measures the signal power of the serving cell and the neighbour cells periodically to assess the quality of each cell to be used in handover decisions.

With the different sampling rates of current arrangements, one or other of the following issues may arise. A UE with a slow sampling rate acquires a lower number of samples (or statistics) which can lead to inaccurate measurements. Inaccurate measurements can lead to erroneous mobility decisions. On the other hand, the power consumption of a UE increases with an increased sampling rate which leads drainage of UE battery over time.

As such, there is a trade-off between the measurement accuracy and power consumption when sampling rate per panel per cell is considered.

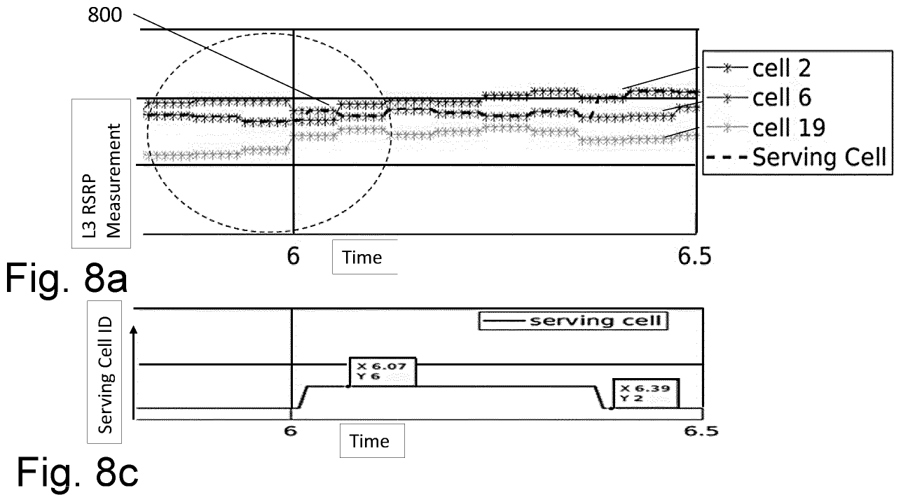

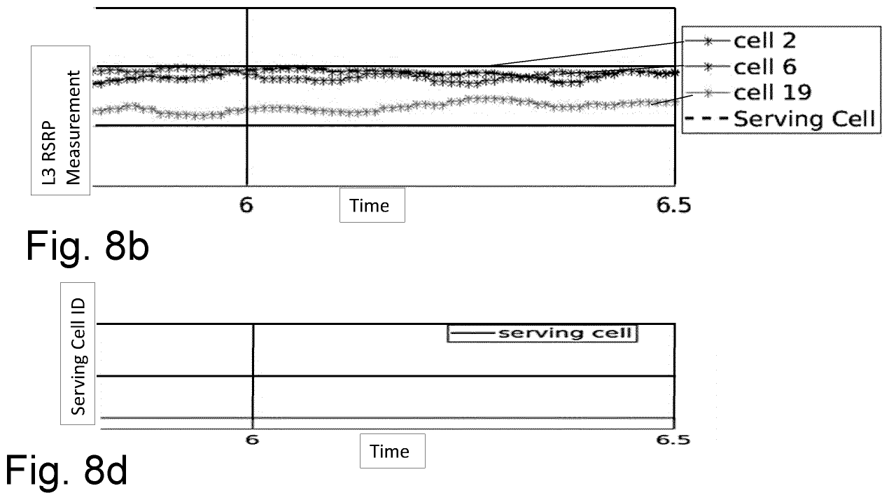

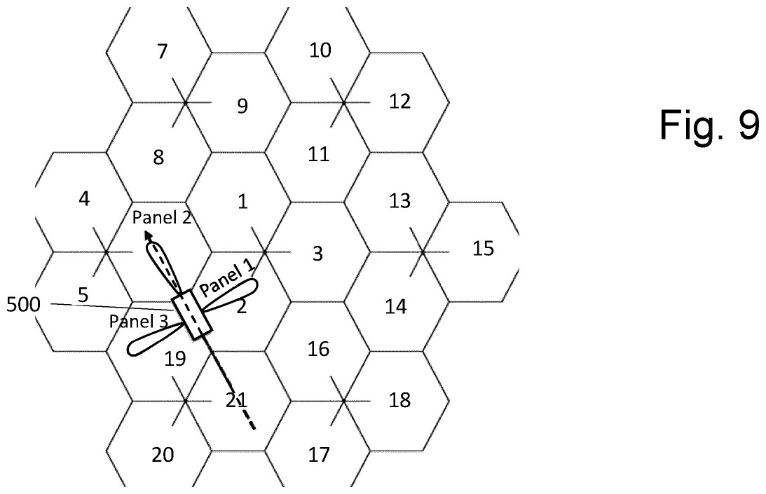

FIGS. 8a to d illustrate an example mobility scenario (the simulation scenario is illustrated in FIG. 9 where UE is moving along a direct path). FIG. 9 shows the UE 500 with the three panel architecture. The UE moves through the cells of the network in the direction of the arrow.

FIGS. 8a to 8d illustrate a simulation in time that is varied on x-axis. FIG. 8a shows the RSRP measurements with a 60 ms sampling period, representing a slow sampling rate. FIG. 8b shows the RSRP measurements with a 20 ms sampling period, representing a fast sampling rate. FIG. 8c shows the serving cell ID plotted against time for the 60 ms sampling period. FIG. 8d shows the serving cell ID plotted against time for the 60 ms sampling period.

In this example, every cell in the network transmits a reference signal every 20 ms (SSB synchronization signal block Signal with 20 ms period. At the beginning of the time period covered by the Figures, the UE is served by cell 2 and both cell 2 and cell 6 measurement values are close to each other. In FIG. 8b, UE does a new measurement every 20 ms which follows the rapid changes in the received signal power. On the other hand, in FIG. 8a, UE does a new measurement every 60 ms (although both cells transmit reference signals every 20 ms).

As can be seen from FIG. 8a, the lowest cell measurement is associated with cell 19. Initially cell 6 has the strongest measured signal strength although cell 2 (which has a signal strength below that of cell 6 but higher than cell 19) is the serving cell. In FIG. 8a, cell 2 becomes and stays the strongest signal at the point referenced 800 The less frequent measurement used in FIG. 8a leads the UE to use non-updated measurements for L3 filtering and for evaluating handover conditions.

As can be seen from FIG. 8b, the lowest cell measurement is still associated with cell 19. Initially cell 6 has the strongest measured signal strength although cell 2 (which has a signal strength below that of cell 6 but higher than cell 19) is the serving cell. In FIG. 8b, the signal strength of cell 2 is strong and is sometimes higher and sometimes lower than that of cell 2. However, as the difference between the signal strength of cell 6 when higher than that of cell 2 is relatively small, cell 2 remains the serving cell. Thus in FIG. 8b, it is clearly seen just before time 6 (s) that the value of L3 RSRP measurement of cell 6 drops down and the L3 RSRP measurement of serving cell 2 increases after some time (see in FIG. 8b) and this is not observed by UE with 60 ms sampling period due to stale samples (see the circled area in FIG. 8a). As a consequence, UE handovers to cell 6 at time 6 (as illustrated in FIG. 8c) although UE could have stayed in the serving cell 2 (as illustrated in FIG. 8d) to avoid unnecessary handover, e.g., ping pong.

Some embodiments provide a mechanism to configure mobility parameters of the multi-panel UEs for different sampling rate per panel per cell.

Some embodiments aim to improve the mobility performance by mitigating the measurement accuracy related mobility problems that originate from a low sampling rate per panel per cell. To achieve this, the mobility parameters that are used to trigger the mobility events, e.g., handovers, are adapted to UE side sampling rate changes.

In some embodiments a network controlled mobility parameter is updated for different sampling rates per panel per cell. The network may configure the UE to report the sampling rate per panel per cell. The UE reports the sampling rate per panel per cell. The UE reports when it is connected to a cell for the first time. The UE reports when the sampling rate per panel per cell is updated at the UE side. Based on the reported sampling rate, the network updates the mobility parameters, if needed.

In other embodiments, the UE autonomously updates one or more mobility parameters for different sampling rate per panel per cell. The network configures mobility parameters (for example handover offset, Time-to-trigger, L3 filtering coefficient, etc). This may be for a plurality of handover conditions. Each mobility parameter/handover condition corresponds to a particular sampling rate per panel per cell. The UE updates the mobility parameters autonomously when the sampling rate per panel per cell changes requiring an update on the mobility parameters (based on the mobility parameters configured by the network).

Thus in some embodiments, the network provides sets of parameters where a set of one or more parameters is used by UE when the UE changes the sampling rate. The conditions that defines which set of parameters to be used is defined by the network and UE follows those defined conditions to change the parameters in use. For example, UE uses X dB offset if sampling rate is A, and uses Y dB offset if sampling rate is B. A, B, X and Y are defined by the network, and UE changes the parameters in use based on the conditions defined by the network.

The parameters may comprise one or more of time to trigger, a handover offset and a L3 filter coefficient.

The conditions may be the sampling rate and the identity of the cell in question.

As discussed previously, a UE with multiple panels, can decide the sampling rate per panel per cell as the panel activation is controlled by the UE and may be implementation specific. As shown in FIGS. 8a to 8d, a MPUE with a same mobility parameter configuration would experience different mobility events when a different sampling rate per panel is used. In some embodiments, it is proposed that the network would adapt the mobility parameters for different sampling rates of each UE in the network. This may be network controlled or be provided by a UE autonomous parameter update for different sampling rates per panel per cell.

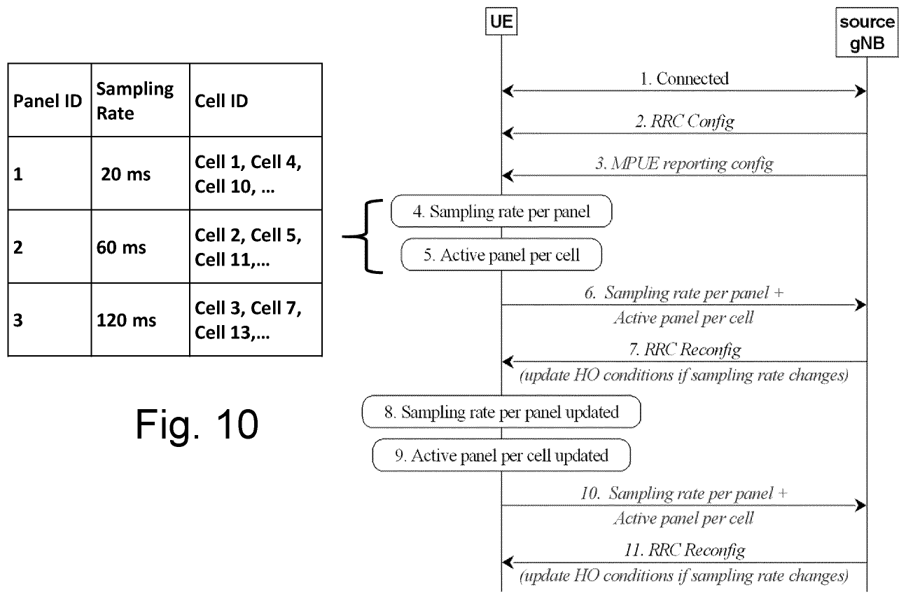

FIG. 10 shows an example embodiment which uses network controlled mobility parameter adaptation for changing the sampling rate per panel per cell. The UE informs network whenever a sampling rate per panel per cell changes and the network updates the mobility parameters accordingly.

As referenced 1 in FIG. 10, the UE and the source base station are connected.

As referenced 2 in FIG. 10, when the UE is served by a cell (the source cell), the network provides a set of conditions to be monitored by the UE to decide on handovers. This may be as part of the RRC (radio resource control) configuration.

As referenced 3 in FIG. 10, of FIG. 6, the network (via the source cell) configures the MPUE to report the sampling rate per panel and active panel per cell over time. Active panel per cell is the panel which the UE uses to carry measurements, e.g., L3 measurements, for the serving and/or a target cell.

In one embodiment, this could be a separate message from RRC Reconfiguration (referenced 2) configuring UE for L3 measurement reporting. In another embodiment, the MPUE reporting configuration is included in RRC Re-configuration message (referenced 2).

The MPUE reporting configuration may be one or more of:
Event driven, e.g., UE reports the sampling rate on panels if there is an update (this may be a primary option); and
Periodic, where the UE reports the sampling rate on all panels periodically (this may be secondary option).

The report provided by the UE may comprise for each panel, one or more of the following:

Panel ID; sampling rate for that panel; and the cell ID of the cells being monitored by that panel. The content of the report, i.e., sampling rate per panel per cell, is schematically indicated by the table of FIG. 10.

As referenced 4 in FIG. 10, the sampling rate per panel is determined by the MPUE.

As referenced 5 in FIG. 10, the active panel per cell is determined by the MPUE. It should be appreciated that the sampling rate per panel and the active panel per cell may be determined at the same time or in either order.

As referenced 6 in FIG. 10, after the MPUE reporting is configured, the UE reports the sampling rate information to the serving cell for the first time. This in the sampling rate per panel and the active panel per cell information

As referenced 7 in FIG. 10, the network determines if the mobility parameters/handover conditions need to be updated based on the sampling rates reported in message 6 in FIG. 10. If so the network updates the mobility parameters/handover conditions and provides the updated mobility parameters/handover conditions to the UE. This may be in a RRC reconfiguration message or any other suitable message.

As referenced 8 in FIG. 10, the sampling rate per panel is updated.

As referenced 9 in FIG. 10, the active panel per cell is updated by the MPUE. It should be appreciated that the sampling rate per panel and the active panel per cell may be updated at the same time or in either order. In some embodiments, only one of the sampling rate per panel and the active panel per cell may be updated.

In the case that the MPUE reporting is configured as event driven reporting, this is reported when the sampling rate per panel per cell changes. In the case of periodic reporting, a change in the sampling rate is captured in the next report. The reporting is referenced 10 in FIG. 10.

If required, the network updates the mobility parameters/handover conditions (in message 11 in FIG. 10) based on the sampling rates updated in message 10 in FIG. 10.

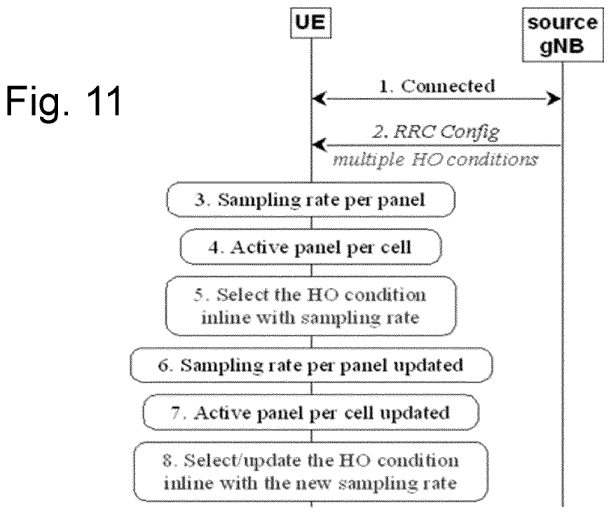

FIG. 11 shows an example embodiment which uses a UE autonomous mobility parameter adaptation for changing sampling rate per panel per cell. Here, the network provides the list of mobility parameters to be used for each cell and each sampling rate per panel to the UE. Then, the UE updates the mobility parameters in use whenever the sampling rate per panel per cell is updated.

As referenced 1 in FIG. 11, the UE and the source base station are connected.

As compared to the embodiment of FIG. 10, the content of the RRC configuration message (message 2 in FIG. 11) is extended from having a single handover condition/mobility parameter set to include a plurality of handover conditions/mobility parameter sets per cell. Alternatively this information may be provided by a separate message.

In one embodiment for a given cell, there will be a plurality of handover conditions/mobility parameter sets where each condition/set refers to a particular sampling rate per panel.

In one embodiment for a given cell, there will be a plurality of handover conditions/mobility parameter sets where each condition/set refers to a range of sampling rates panels, e.g.

$$HO Condition Cell 2 = \{ \begin{matrix}{t}_{TTT} = 80 ms \& offset = 1 dB , & 20 ms < sampling period on cell 2 < 60 ms \\ {t}_{TTT} = 160 ms \& offset = 2 dB , & 60 ms \leq sampling period on cell 2 < 200 ms \\ {t}_{TTT} = 200 ms \& offset = 3 dB , & 200 ms \leq sampling period on cell 2\end{matrix}$$

As referenced 3 in FIG. 11, the UE sets the sampling rate per panel.

As referenced 4 in FIG. 11, the UE determines which panels are active for which cell. The setting of the sampling rate and determining which panels are active for which cell can take place in either order or at the same time.

As referenced 5 in FIG. 11, the UE selects the handover condition for each cell to be used based on the panel that is selected for each cell and for the actual sampling rate of the selected panel. The UE uses the information received from the source cell.

As referenced 6 in FIG. 11, the UE updates the sampling rate per panel.

As referenced 7 in FIG. 11, the UE updates which panels are active for which cell. Only one of the sampling rate and which panels are active for which cell may be updated. The updating of the sampling rate and/or which panels are active for which cell can take place in either order or at the same time.

As referenced 8 in FIG. 11, when the UE updates the sampling rate and/or which panels are active for which cell, the UE checks the handover conditions provided in message 2 in FIG. 7, and update the mobility parameters, if an update is required.

In either the network controlled or UE autonomous mobility parameter adaption methods such as described above the following can lead to an update on the mobility parameters.

Consider the following examples. The UE is served by cell A and there are three panels on UE, i.e., Panel #1, Panel #2 and Panel #3. UE uses Panel #1 to measure cell quality of serving cell A (it can also be a target cell).

In a first scenario, the UE decides to change (increase/decrease) the sampling rate on Panel #1 and keep using Panel #1 measurements for deriving the cell quality of serving cell A. This will lead to an update of the mobility parameters as the sampling rate of the panel that is used for measurements of a cell changes.

In a second scenario, the UE changes the panel that is used to measure the cell quality of serving cell A, e.g., from Panel #1 to Panel #2 and sampling rate of Panel #1 is different than sampling rate of Panel #2. Again, the sampling rate of the panel that is used for measurements of a cell changes and the mobility parameters are updated accordingly.

Some embodiments enable the network to configure mobility parameters of a UE for different UE side sampling rates per panel per cell. Some embodiments enable adaptation of mobility parameters for dynamic sampling rate per cell that changes over time. Hence, the mobility problems, e.g., ping-pongs or failures, that are caused by a mismatch between the sampling rate per panel per cell and mobility parameters may be reduced or avoided. This may lead to an improvement in mobility performance.

In some embodiments, the sampling rate or frequency is determined—the sampling rate or frequency is the number of samples taken in a given period. In other embodiments the sampling interval or sampling period T may alternatively or additionally be determined. A measurement is taken every T seconds. The sampling frequency or sampling rate, fs, is the average number of samples obtained in one second, thus fs=1/T.

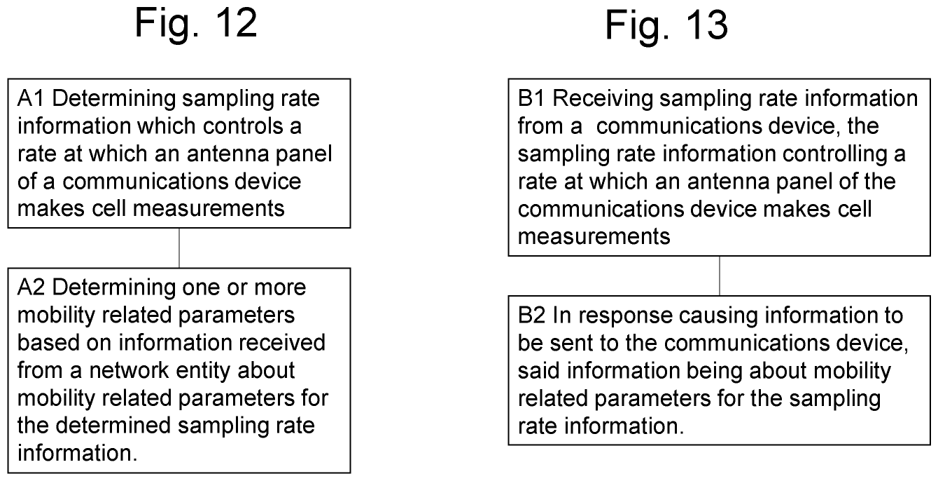

Reference is made to FIG. 12 which shows a method which may be performed by an apparatus. The apparatus may be as shown in FIG. 3 or 4. The apparatus may be a communications device or provided in a communications device.

As referenced A1, the method comprises determining sampling rate information which controls a rate at which an antenna panel of a communications device makes cell measurements.

As referenced A2, the method comprises determining one or more mobility related parameters based on information received from a network entity about mobility related parameters for the determined sampling rate information.

Reference is made to FIG. 13 which shows a method which may be performed by an apparatus. The apparatus may be as shown in FIG. 4. The apparatus may be a network entity or provided by a network entity.

As referenced B, the method comprises receiving sampling rate information from a communications device, the sampling rate information controlling a rate at which an antenna panel of the communications device makes cell measurements; and

As referenced B2, the method comprises in response causing information to be sent to the communications device, said information being about mobility related parameters for the sampling rate information.

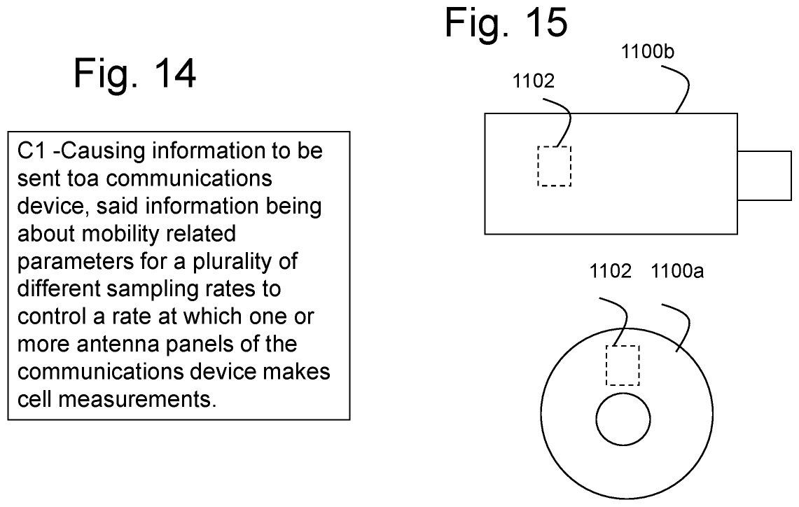

Reference is made to FIG. 14 which shows a method which may be performed by an apparatus. The apparatus may be as shown in FIG. 4. The apparatus may be a network entity or provided by a network entity.

As referenced C1, the method comprises causing information to be sent to a communications device, said information being about mobility related parameters for a plurality of different sampling rates to control a rate at which one or more antenna panels of the communications device makes cell measurements.

FIG. 15 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the methods of FIG. 12, 13 or 14.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

It should be appreciated that some embodiments may be used with a communications device which have only one antenna panel. Other embodiments may be used with communications devices which have two or more antenna panels. Some embodiments may have three, four or even more antenna panels.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 12, 13 or 14, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware; and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one memory storing instructions that, when executed by the at least one processor, cause the apparatus at least to:
determine sampling rate information which controls a rate at which an antenna panel of a communications device makes cell measurements; and
determine one or more mobility related parameters based on information received from a network entity about mobility related parameters for the determined sampling rate information.

2. The apparatus as claimed in claim 1, wherein the apparatus is caused to determine for each of a plurality of different antenna panels of the communications device, respective sampling rate information and associated mobility related parameters.

3. The apparatus as claimed in claim 1, wherein the information received from a network about mobility related parameters comprises cell specific information.

4. The apparatus as claimed in claim 1, wherein the apparatus is caused to receive the information from the network entity about mobility related parameters for a plurality of different sample rates.

5. The apparatus as claimed in claim 4, wherein the apparatus is caused to receive the information from the network entity about mobility related parameters for the plurality of different sample rates for a plurality of different cells.

6. The apparatus as claimed in claim 4, wherein the apparatus is caused to receive information about one or more conditions and to use the information about one or more conditions to determine which mobility parameters are to be used.

7. The apparatus as claimed in claim 1, wherein the apparatus is caused to send the sampling rate information by the communications device to the network entity and in response to receive the information from the network entity about mobility related parameters for the sampling rate information.

8. The apparatus as claimed in claim 7, wherein the apparatus is caused to send cell identity information associated with the sampling rate information by the communications device to the network entity and in response to receive the information from the network entity about mobility related parameters for the determined sampling rate information for the identified cell.

9. The apparatus as claimed in claim 1, wherein the mobility parameters are handover related parameters.

10. The apparatus as claimed in claim 1, wherein the mobility parameters comprise one or more of time to trigger, a handover offset and a L3 filter coefficient.

11. An apparatus comprising:
at least one processor; and
at least one memory storing instructions that, when executed by the at least one processor, cause the apparatus at least to:
receive sampling rate information from a communications device, the sampling rate information controlling a rate at which an antenna panel of the communications device makes cell measurements; and
in response, send information to the communications device, said information being about mobility related parameters for the sampling rate information.

12. The apparatus as claimed in claim 11, wherein the sampling rate information comprises respective sampling rate information for each of a plurality of different antenna panels of the communications device.

13. The apparatus as claimed in claim 11, wherein the apparatus is caused to receive cell identity information associated with the sampling rate information from the communications device, and in response, send the information to the communications device about mobility related parameters for the determined sampling rate information for the identified cell.

14. An apparatus comprising:
at least one processor; and
at least one memory storing instructions that, when executed by the at least one processor, cause the apparatus at least to:
send information to a communications device, said information being about mobility related parameters for a plurality of different sampling rates to control a rate at which one or more antenna panels of the communications device makes cell measurements.

15. The apparatus as claimed in claim 14, wherein the information about mobility related parameters comprises cell specific information.

16. The apparatus as claimed in claim 14, wherein the apparatus is caused to send information about one or more conditions to the communications device, said one or more conditions being used by the communications device to determine which mobility parameters are to be used.

17. The apparatus as claimed in claim 11,
wherein the mobility parameters are handover related parameters.

18. The apparatus as claimed in claim 11, wherein the mobility parameters comprise one or more of time to trigger, a handover offset and a L3 filter coefficient.

19. A method comprising:
determining sampling rate information which controls a rate at which an antenna panel of a communications device makes cell measurements; and
determining one or more mobility related parameters based on information received from a network entity about mobility related parameters for the determined sampling rate information.

20-21. (canceled)

22. A non-transitory computer program product comprising computer program instructions for causing an apparatus to perform the method of claim 19.
